(19) United States
(12) Patent Application Publication
(10) Pub. No.: US 2019/0152264 A1
(43) Pub. Date: May 23, 2019

(54) HEAVY-DUTY PNEUMATIC TIRE

(71) Applicant: BRIDGESTONE CORPORATION, Tokyo (JP)

(72) Inventor: Kentaro SAEKI, Tokorozawa-shi (JP)

(73) Assignee: BRIDGESTONE CORPORATION, Tokyo (JP)

(21) Appl. No.: 16/300,013

(22) PCT Filed: Dec. 5, 2016
(86) PCT No.: PCT/JP2016/086081

§ 371 Date: Nov. 8, 2018

(30) Foreign Application Priority Data
Jun. 20, 2016 (JP) 2016-121449

(51) Int. Cl. B60C 9/28; B60C 9/20; B60C 11/00; B60C 15/00

(52) U.S. Cl. CPC B60C 9/28; B60C 9/20; B60C 11/0083; B60C 2009/2077; B60C 2009/2016; B60C 2200/06; B60C 15/0009

(57) ABSTRACT

A heavy-duty pneumatic tire includes an inclined belt in which reinforcing elements of a first belt layer and reinforcing elements of a second belt layer extend at an inclination angle of 5° to 30° relative to the tire circumferential direction in such a manner that the reinforcing elements of the first belt layer cross the reinforcing elements of the second belt layer. The shortest distance d between the reinforcing elements of the first belt layer and the reinforcing elements of the second belt layer is 0.64 mm or less. The outer edge of a carcass folded-up portion in the tire radial direction is located further inward in the tire radial direction than the tire maximum width position.

### TECHNICAL FIELD

The present disclosure relates to a heavy-duty pneumatic tire.

### BACKGROUND

In known heavy-duty pneumatic tires used in heavy-load vehicles, such as trucks and buses, a belt having a plurality of belt layers is provided further outward in the tire radial direction than the crown portion of the carcass to improve durability, to preserve the tire shape when the tire is filled to a high internal pressure, and to improve the uneven wear resistance by controlling radial growth. For example, see patent literature (PTL) 1.

### CITATION LIST

### Patent Literature

PTL 1: JP2014189243A

### SUMMARY

### Technical Problem

Increased interest in environmental issues has led to higher demand for fuel-efficient tires. In the above heavy-duty pneumatic tires with a plurality of belt layers, however, the rolling resistance may increase due to the increased weight from the belt layers. Hence, demand exists for controlling energy loss to reduce the rolling resistance and improve fuel efficiency.

In light of these circumstances, the present disclosure aims to provide a heavy-duty pneumatic tire with reduced rolling resistance.

### Solution to Problem

A summary of the present disclosure is as follows.

A heavy-duty pneumatic tire according to the present disclosure includes:

a carcass including a carcass body extending toroidally between a pair of bead portions and carcass folded-up portions extending from the carcass body and folded up at the bead portions from inside to outside in a tire width direction; and

an inclined belt, further outward in a tire radial direction than a crown portion of the carcass, including a first belt layer and a second belt layer further inward in the tire radial direction than the first belt layer, reinforcing elements of the first belt layer and reinforcing elements of the second belt layer extending at an inclination angle of 5° to 30° relative to a tire circumferential direction in such a manner that the reinforcing elements of the first belt layer cross the reinforcing elements of the second belt layer;

such that an outer edge of the carcass folded-up portions in the tire radial direction is located further inward in the tire radial direction than a tire maximum width position; and

such that a shortest distance d between the reinforcing elements of the first belt layer and the reinforcing elements of the second belt layer is 0.64 mm or less.

In the present disclosure, the “inclination angle” and the “shortest distance” refer to the inclination angle and the shortest distance in a reference state in which the heavy-duty pneumatic tire is assembled with an applicable rim and inflated to the prescribed internal pressure with no load thereon. As illustrated in FIG. 4, the “shortest distance” refers to the shortest distance between surfaces of the reinforcing elements.

Here, the “applicable rim” refers to a standard rim of an applicable size, such as the Measuring Rim in the STANDARDS MANUAL of the European Tire and Rim Technological Organization (ETRTO) in Europe or the Design Rim in the YEAR BOOK of the Tire and Rim Association, Inc. (TRA) in the USA, that is described in industrial standards effective in the region where the tire is manufactured and used, such as the JATMA YEAR BOOK published by the Japan Automobile Tyre Manufacturers Association (JATMA) in Japan, the STANDARDS MANUAL of the ETRTO, and the YEAR BOOK of the TRA. The “prescribed internal pressure” represents the internal air pressure corresponding to the maximum load capability for each applicable size and ply rating prescribed by the aforementioned JATMA YEAR BOOK and the like. The “maximum load capability” represents the maximum mass, under the aforementioned standards, permitted to be loaded on the tire.

In the present disclosure, the “tread thickness” refers to the distance in the tire radial direction, at the tire equatorial plane, from the surface of the tread to the tire inner surface in the reference state. When a groove is provided at the tire equatorial plane, however, then a profile line that the tread would have without the groove is imagined, and the tread thickness refers to the distance in the tire radial direction, at the tire equatorial plane, from the imaginary profile line to the tire inner surface.

### Advantageous Effect

The present disclosure can provide a heavy-duty pneumatic tire with reduced rolling resistance.

### BRIEF DESCRIPTION OF THE DRAWINGS

In the accompanying drawings:

FIG. 1 is a partial cross-sectional view in the tire width direction of a heavy-duty pneumatic tire according to an embodiment of the present disclosure;

FIG. 2 schematically illustrates the belt structure of the heavy-duty pneumatic tire in FIG. 1;

FIG. 3A is a partial cross-sectional view in the tire width direction of an example of a known heavy-duty pneumatic tire, and FIG. 3B is a partial cross-sectional view in the tire width direction of a heavy-duty pneumatic tire according to an embodiment of the present disclosure;

FIG. 4 illustrates the distance between reinforcing elements of the first belt layer and reinforcing elements of the second belt layer; and

FIG. 5 illustrates the neutral axis of bending deformation of the belt layer when the tire rolls under a load.

### DETAILED DESCRIPTION

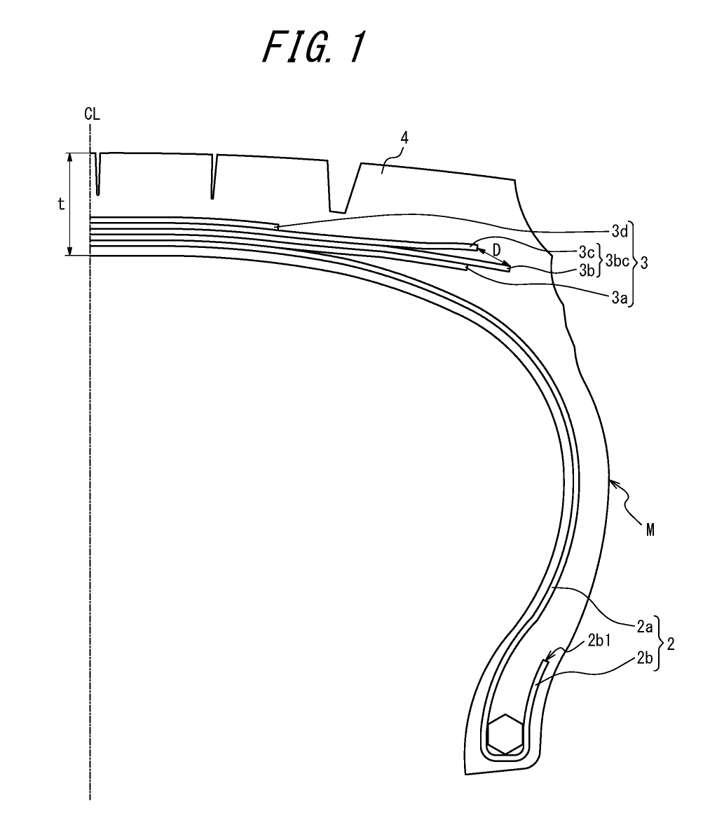

Embodiments of the present disclosure are described below in detail with reference to the drawings. FIG. 1 is a partial cross-sectional view in the tire width direction of a heavy-duty pneumatic tire (also simply “tire”) according to an embodiment of the present disclosure. FIG. 1 illustrates only one of two halves of the tire, separated in the tire width direction by the tire equatorial plane CL, but the other half has a similar structure. FIG. 1 depicts the tire in a state where the tire has been assembled with an applicable rim and inflated to the prescribed internal pressure with no load thereon.

A tire 1 of the present embodiment includes a carcass 2, a belt 3, and a tread 4. The carcass 2 extends toroidally between bead cores embedded in a pair of bead portions. The belt 3 and the tread 4, in this order, are further outward in the tire radial direction than a crown portion of the carcass 2.

In the example illustrated in FIG. 1, the carcass 2 is composed of a pair of carcass plies, but the number of carcass plies may be more than two as necessary. The cords in the carcass 2 may be made of any material. For example, metal fiber cords such as steel cords may be used.

The carcass 2 is made of a carcass body 2a extending toroidally between the pair of bead portions and carcass folded-up portions 2b extending from the carcass body 2a and folded up at the bead portions from the inside to the outside in the tire width direction. When the tire has been assembled with an applicable rim and inflated to the prescribed internal pressure with no load thereon, a tire radial outer edge 2b1 of the carcass folded-up portion 2b is located further inward in the tire radial direction than a tire maximum width position M.

In the present embodiment, the belt 3 is made of four belt layers 3a to 3d. A first belt layer 3c and a second belt layer 3b, which is located further inward in the tire radial direction than the first belt layer 3c (adjacent to the first belt layer 3c in this example), form a two-layered inclined belt 3bc. A single-layer outer belt layer 3d is located further outward in the tire radial direction than the inclined belt 3bc. A single-layer inner belt layer 3a is located further inward in the tire radial direction than the inclined belt 3bc. The number of belt layers in the present embodiment is four, but to reduce weight, a two-layer or three-layer belt layer may be formed by omitting one or both of the outer belt layer 3d and the inner belt layer 3a. To improve tire durability, the number of belt layers located further outward or inward in the tire radial direction from the inclined belt 3bc may be increased for a total of five or more belt layers. Alternatively, another belt layer may be provided between the first belt layer and the second belt layer in the tire radial direction.

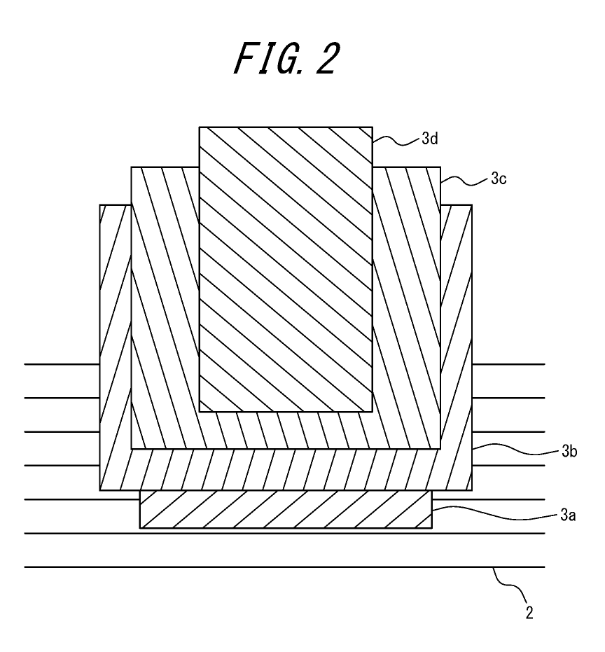

FIG. 2 schematically illustrates the belt structure of the heavy-duty pneumatic tire in FIG. 1. As illustrated in FIG. 2, reinforcing elements of the first belt layer 3c and reinforcing elements of the second belt layer 3b extend at an inclination angle of 5° to 30° relative to the tire circumferential direction in such a manner that the reinforcing elements of the first belt layer 3c cross the reinforcing elements of the second belt layer 3b. As illustrated in FIG. 2, in the present embodiment, the reinforcing elements of the first belt layer 3c and the reinforcing elements of the second belt layer 3b extend at the same inclination angle relative to the tire circumferential direction in opposite directions in such a manner that the reinforcing elements of the first belt layer 3c cross the reinforcing elements of the second belt layer 3b. In the present disclosure, however, the reinforcing elements of the first belt layer 3c and the reinforcing elements of the second belt layer 3b may extend at different inclination angles relative to the tire circumferential direction in opposite directions in such a manner that the reinforcing elements of the first belt layer 3c cross the reinforcing elements of the second belt layer 3b. In the present disclosure, the reinforcing elements of the first belt layer 3c and the reinforcing elements of the second belt layer 3b may also extend at different inclination angles relative to the tire circumferential direction in the same direction (with one side in the tire circumferential direction of the reinforcing elements in each layer being inclined towards the same side in the tire width direction) in such a manner that the reinforcing elements of the first belt layer 3c cross the reinforcing elements of the second belt layer 3b. In the present embodiment, the reinforcing elements are steel cords, but cords of a different material or filament may also be used.

In the tire of the present embodiment, the inclination angle of the reinforcing elements of the outer belt layer 3d relative to the tire circumferential direction is greater than the inclination angle of the reinforcing elements of the first belt layer 3c and the reinforcing elements of the second belt layer 3b relative to the tire circumferential direction, as illustrated in FIG. 2. Furthermore, in the present embodiment, the inclination angle of the reinforcing elements of the inner belt layer 3a relative to the tire circumferential direction is greater than the inclination angle of the reinforcing elements of the first belt layer 3c and the second belt layer 3b relative to the tire circumferential direction, as illustrated in FIG. 2.

In the tire of the present embodiment, the reinforcing elements of the outer belt layer 3d and the reinforcing elements of the inner belt layer 3a extend at the same inclination angle relative to the tire circumferential direction in opposite directions in such a manner that the reinforcing elements of the outer belt layer 3d cross the reinforcing elements of the inner belt layer 3a, as illustrated in FIG. 2. In the present disclosure, however, the reinforcing elements of the outer belt layer 3d and the reinforcing elements of the inner belt layer 3a may extend at different inclination angles relative to the tire circumferential direction in opposite directions in such a manner that the reinforcing elements of the outer belt layer 3d cross the reinforcing elements of the inner belt layer 3a. In the present disclosure, the reinforcing elements of the outer belt layer 3d and the reinforcing elements of the inner belt layer 3a may also extend at different inclination angles relative to the tire circumferential direction in the same direction (with one side in the tire circumferential direction of the reinforcing elements in each layer being inclined towards the same side in the tire width direction) in such a manner that the reinforcing elements of the outer belt layer 3d cross the reinforcing elements of the inner belt layer 3a.

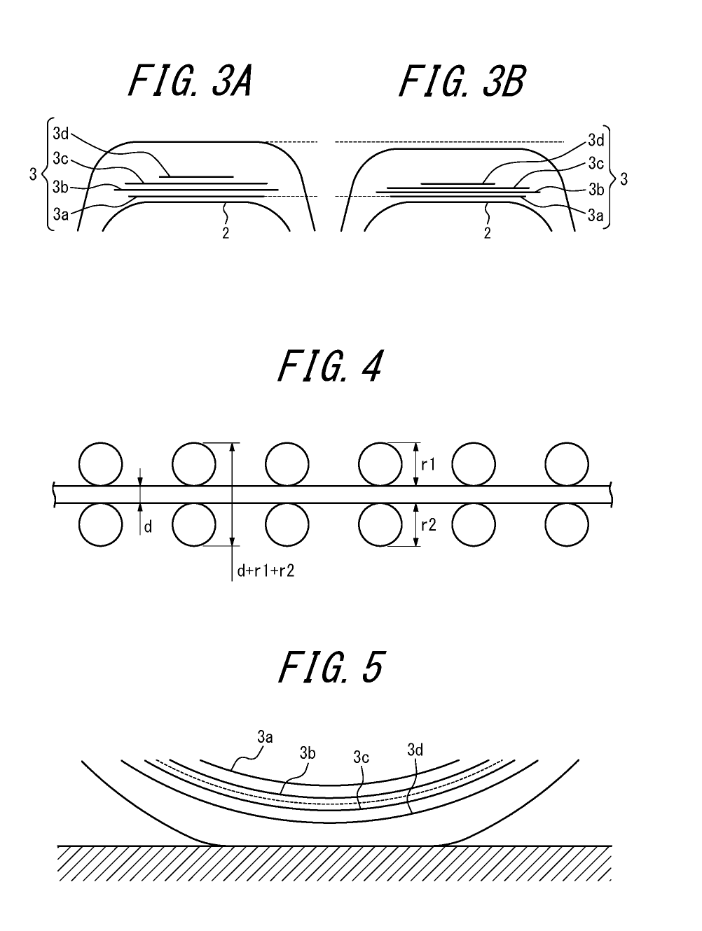

FIG. 3A is a partial cross-sectional view in the tire width direction of an example of a known heavy-duty pneumatic tire, and FIG. 3B is a partial cross-sectional view in the tire width direction of a heavy-duty pneumatic tire according to an embodiment of the present disclosure. FIG. 4 illustrates the distance between reinforcing elements of the first belt layer and reinforcing elements of the second belt layer.

In a heavy-duty pneumatic tire, fretting wear may occur due to contact between reinforcing elements when a heavy load is applied, reducing the durability of the reinforcing elements. The shortest distance between reinforcing elements of different belt layers has therefore typically been maintained relatively high. As schematically illustrated in FIG. 3B by comparison with FIG. 3A, however, the tire of the present embodiment instead has a shortest distance d (see FIG. 4) between the reinforcing elements of the first belt layer 3c and the reinforcing elements of the second belt layer 3b of 0.64 mm or less.

The effects of the heavy-duty pneumatic tire of the present embodiment are described below.

First, the tire of the present embodiment includes four belt layers 3a to 3d as the belt 3, thereby increasing the tire durability even under a heavy load and maintaining the tire shape when the tire is filled to a high internal pressure. Furthermore, this structure can control radial growth and improve uneven wear resistance.

FIG. 5 illustrates the neutral axis of bending deformation of the belt layer when the tire rolls under a load. In a tire including the above-described inclined belt 3bc in which the reinforcing elements extend at a small inclination angle relative to the tire circumferential direction, i.e. an inclination angle of 5° to 30°, the neutral axis of bending deformation of the belt layer when the tire rolls under a load is located between the belt layers 3c, 3b that form the inclined belt 3bc, as illustrated in FIG. 5. When the belt 3 is formed only by the inclined belt 3bc (i.e. only by the two belt layers 3c, 3b), the neutral axis of bending deformation is located between the belt layers 3c, 3b that form the inclined belt 3bc. In the case of a three-layer or four-layer belt layer that includes either or both of the outer belt layer 3d and the inner belt layer 3a, the aforementioned neutral axis of bending deformation is located between the belt layers 3c, 3b forming the inclined belt 3bc when the inclination angle relative to the tire circumferential direction of the reinforcing elements of the outer belt layer 3d (when the outer belt layer 3d is included) and the inclination angle relative to the tire circumferential direction of the reinforcing elements of the inner belt layer 3a (when the inner belt layer 3a is included) are greater than the inclination angle relative to the tire circumferential direction of the reinforcing elements of the first belt layer 3c and the reinforcing elements of the second belt layer 3b. The same holds when the number of belt layers further outward or inward in the tire radial direction than the inclined belt 3bc is two or greater. In the case of an additional belt layer being included between the first belt layer 3c and the second belt layer 3b in the tire radial direction, the aforementioned neutral axis of bending deformation is still located between the first belt layer 3c and the second belt layer 3b when the inclination angle relative to the tire circumferential direction of the reinforcing elements of the additional belt layer is greater than the inclination angle relative to the tire circumferential direction of the reinforcing elements of the first belt layer 3c and the reinforcing elements of the second belt layer 3b.

The shortest distance d in the tire of the present embodiment is 0.64 mm or less, which allows a reduction in the sum of i) the distance between the central axis of the bending deformation and the reinforcing elements of the first belt layer 3c and ii) the distance between the central axis of the bending and the reinforcing elements of the second belt layer 3b. This also allows a reduction in the compressive and tensile forces experienced by the reinforcing elements of the inclined belt 3bc and a reduction in the distortion energy loss of rubber between the reinforcing elements of the first belt layer 3c and the reinforcing elements of the second belt layer 3b, thereby reducing the rolling resistance.

Furthermore, the tire of the present embodiment can improve the durability of the reinforcing elements by reducing the compressive and tensile forces experienced by the reinforcing elements of the inclined belt 3bc.

The tire of the present embodiment thus uses the four belt layers 3a to 3d to ensure the aforementioned properties of a heavy-duty pneumatic tire while reducing the energy loss of rubber in the inclined belt 3bc to reduce the rolling resistance. At this time, the tire of the present embodiment also ensures durability of the reinforcing elements.

Here, to further reduce the distortion energy loss of the rubber in the inclined belt 3bc, thereby further reducing the rolling resistance, the shortest distance d is more preferably 0.60 mm or less. On the other hand, to control fretting wear between reinforcing elements, the shortest distance d is preferably 0.50 mm or more.

In the present disclosure, the tire preferably includes the tread 4 further outward in the tire radial direction than the inclined belt 3bc, and a thickness t of the tread 4 is preferably 20 mm to 35 mm, as in the present embodiment. As illustrated in FIG. 3B by comparison with FIG. 3A, the tire of the present embodiment has a lower shortest distance between the reinforcing elements of different belt layers. This allows a reduction in the thickness t of the tread 4 while maintaining a certain distance in the tire radial direction from the tread surface to the tire radial direction outermost belt layer 3d and a certain distance in the tire radial direction from the tire radial direction innermost belt layer 3a to the carcass 2. Setting the thickness t of the tread 4 in the aforementioned range can reduce the volume of the tread rubber, lower heat buildup, and further reduce rolling resistance. Three grooves are provided in the tread 4 within the range illustrated in FIG. 1, but the tread pattern is not restricted in the present disclosure.

In the present disclosure, when the outer belt layer 3d is provided further outward in the tire radial direction than the inclined belt 3b, the shortest distance da between the reinforcing elements of the first belt layer 3c and the reinforcing elements of the outer belt layer 3d is preferably 0.6 mm or less. This structure can reduce the distance between the reinforcing elements of the outer belt layer 3d and the neutral axis of bending and reduce the energy loss of rubber between the reinforcing elements of the outer belt layer 3d and the reinforcing elements of the first belt layer 3c, thereby further reducing the rolling resistance. Here, to further reduce the distortion energy loss of the rubber between the reinforcing elements of the outer belt layer 3d and the reinforcing elements of the first belt layer 3c, thereby further reducing the rolling resistance, the shortest distance da is more preferably 0.70 mm or less and even more preferably 0.60 mm or less. On the other hand, to control fretting wear between reinforcing elements, the shortest distance da is preferably 0.50 mm or more.

In the present disclosure, when the inner belt layer 3a is included further inward in the tire radial direction than the inclined belt 3b, the shortest distance db between the reinforcing elements of the second belt layer 3b and the reinforcing elements of the inner belt layer 3a is preferably 0.6 mm or less. This structure can reduce the distance between the reinforcing elements of the inner belt layer 3a and the neutral axis of bending and reduce the energy loss of rubber between the reinforcing elements of the inner belt layer 3a and the reinforcing elements of the second belt layer 3b, thereby further reducing the rolling resistance. Here, to reduce the distortion energy loss of the rubber between the reinforcing elements of the inner belt layer 3a and the reinforcing elements of the second belt layer 3b, thereby reducing the rolling resistance, the shortest distance db is more preferably 0.70 mm or less and even more preferably 0.60 mm or less. On the other hand, to control fretting wear between reinforcing elements, the shortest distance db is preferably 0.50 mm or more.

For the same reasons, when the outer belt layer 3d is included further outward, and the inner belt layer 3a further inward, in the tire radial direction than the inclined belt 3b in the present disclosure, the shortest distance da and the shortest distance db are both preferably 0.70 mm or less, more preferably 0.60 mm or less. On the other hand, to control fretting wear between reinforcing elements, the shortest distance da and the shortest distance db are both preferably 0.50 mm or more.

In the present disclosure, the reinforcing elements of the outer belt layer 3d preferably extend at an inclination angle of 30° to 90° relative to the tire circumferential direction. This structure can reduce the rigidity of the outer belt layer 3d relative to the tire circumferential direction to an appropriate level and control shearing deformation of rubber between the reinforcing elements of the first belt layer 3c and the reinforcing elements of the outer belt layer 3d, thereby further reducing the rolling resistance. For the same reasons, the reinforcing elements of the outer belt layer 3d more preferably extend at an inclination angle of 60° to 90° relative to the tire circumferential direction.

In the present disclosure, the reinforcing elements of the inner belt layer 3a preferably extend at an inclination angle of 30° to 90° relative to the tire circumferential direction. This structure can reduce the rigidity of the inner belt layer 3a relative to the tire circumferential direction to an appropriate level and control shearing deformation of rubber between the reinforcing elements of the second belt layer 3b and the reinforcing elements of the inner belt layer 3a, thereby further reducing the rolling resistance. For the same reasons, the reinforcing elements of the inner belt layer 3a more preferably extend at an inclination angle of 60° to 90° relative to the tire circumferential direction.

In the present disclosure, the sum of

d+r1+r2

is preferably 2.7 mm or more, where r1 is the diameter of the reinforcing elements of the first belt layer 3c, and r2 is the diameter of the reinforcing elements of the second belt layer 3b.

A somewhat large setting for the diameters r1, r2 of the reinforcing elements allows the load of bending deformation to be placed more reliably on the rubber between the reinforcing elements of the first belt layer 3c and the reinforcing elements of the second belt layer. Such a setting also facilitates achievement of the effects of the shortest distanced being 0.64 mm or less and can further reduce the rolling resistance.

Accordingly, the diameters r1, r2 of the reinforcing elements are preferably 0.8 mm to 1.3 mm.

In the present disclosure, the inclination angle of the reinforcing elements of the second belt layer 3b relative to the tire circumferential direction is preferably smaller than the inclination angle of the reinforcing elements of the first belt layer 3c relative to the tire circumferential direction. As a result, the neutral axis of bending can be moved slightly inwards in the tire radial direction between the reinforcing elements of the first belt layer 3c and the reinforcing elements of the second belt layer 3b, and the deformation of rubber on the compression side, which has a relatively large energy loss, can be made relatively smaller than on the tensile side. This can further reduce the rolling resistance.

In the present disclosure, the shortest distance D between a tire widthwise outer edge of the first belt layer 3c and a tire widthwise outer edge of the second belt layer 3b is preferably 15 mm or more, as illustrated in FIG. 1. This can control belt edge separation.

In the present disclosure, the width of the first belt reinforcement layer 3c and the width of the second belt reinforcement layer 3b in the tire width direction are preferably greater than the width of the outer belt layer 3d and the width of the inner belt layer 3a in the tire width direction. The outer belt layer 3d protects from external damage, and it suffices to protect the high-tension central region. The outer belt layer 3d can also reduce the tension between belt layers to reduce the rolling resistance. To achieve both uneven wear resistance and belt durability, the width of the second belt reinforcement layer 3b in the tire width direction is preferably maximized. Furthermore, the width of the outer belt layer 3d in the tire width direction is preferably approximately 40% to 60% of the width of the second belt reinforcement layer 3b in the tire width direction. This is to improve durability with respect to a sudden input of force. In the present disclosure, however, the width of each belt layer in the tire width direction is not restricted to the example embodiment in FIG. 1.

For ease of explanation, FIG. 4 illustrates an example in which the reinforcing elements of adjacent layers are arranged at equal intervals and matching phase. In the present disclosure, however, the number of reinforcing elements embedded in each layer may be changed, and the reinforcing elements may be arranged while shifting the phase.

In the present disclosure, the tire aspect ratio is preferably 50% to 90%.

Embodiments of the present disclosure have been described, but the present disclosure is in no way limited to the above embodiments. Furthermore, examples of the present disclosure are described below, but the present disclosure is in no way limited to these Examples.

### EXAMPLES

To confirm the effects of the present disclosure, test tires with a tire size of 315/70R22.5 according to Examples 1-9 and a Comparative Example were prepared, and the rolling resistance, the uneven wear resistance, and the durability of the reinforcing elements were tested. The tires for Examples 1-7 and the Comparative Example had a tire structure such as the one in FIG. 1. The shortest distances d, da, db, and the aforementioned distance d+r1+r2 differed, as listed in Table 1. The specifications not listed in Table 1 were the same for each tire. The evaluation method in each test is described below. In Table 1, the “inclination angle” refers to the inclination angle relative to the tire circumferential direction. Steel cords were used as the reinforcing elements.

### <Rolling Resistance>

The rolling resistance was measured with a force method conforming to ISO 28580. Table 1 lists relative evaluation results as index values, with the Comparative Example as 100. A smaller index value indicates lower rolling resistance and better performance.

### <Uneven Wear Resistance>

Each of the aforementioned tires was assembled with a 9.00×22.5 size rim, filled to an internal pressure of 900 kPa, and mounted on an indoor drum test machine. Each tire was then run for a distance of 10,000 km at 80 km/h under a load of 39.2 kN. The amount of uneven wear at the shoulder portion of the tread of each tire after test running was then measured. In Table 1, the uneven wear resistance is the inverse of the value obtained by multiplying the wear depth (mm) from the tread surface side by the length of the uneven wear in the tire width direction and dividing by two. Table 1 lists relative evaluation results as index values, with the Comparative Example as 100. A larger index value indicates better uneven wear resistance.

### <Durability of Reinforcing Elements>

Each of the aforementioned tires was assembled with a 9.00×22.5 size rim, filled to an internal pressure of 900 kPa, and mounted on an indoor drum test machine. Each tire was then run for a distance of 10,000 km at 80 km/h under a load of 39.2 kN. The belt was then cut out from the tire, and the amount of cord wear was measured.

Table 1 lists relative evaluation results as index values, with the Comparative Example as 100. A larger index value indicates higher durability of the reinforcing elements.

Table 1 lists the specifications and evaluation results for each tire.

TABLE 1

| | | Exam- | Exam- | Exam- | Exam- | Exam- | Exam- | Exam- | Comparative |
|---|---|---|---|---|---|---|---|---|---|
| | | ple 1 | ple 2 | ple 3 | ple 4 | ple 5 | ple 6 | ple 7 | Example |
| Belt | inclination angle of | 15° | 15° | 15° | 15° | 15° | 15° | 15° | 15° |
| layer | reinforcing | | | | | | | | |
| | elements of first | | | | | | | | |
| | belt layer 3c | | | | | | | | |
| | inclination angle of | 15° | 15° | 15° | 15° | 15° | 15° | 15° | 15° |
| | reinforcing | | | | | | | | |
| | elements of second | | | | | | | | |
| | belt layer 3b | | | | | | | | |
| | inclination angle of | 45° | 45° | 45° | 45° | 45° | 45° | 45° | 45° |
| | reinforcing | | | | | | | | |
| | elements of outer | | | | | | | | |
| | belt layer 3d | | | | | | | | |
| | inclination angle of | 45° | 45° | 45° | 45° | 45° | 45° | 45° | 45° |
| | reinforcing | | | | | | | | |
| | elements of inner | | | | | | | | |
| | belt layer 3a | | | | | | | | |
| Distance | shortest distance | 0.64 | 0.60 | 0.64 | 0.64 | 0.64 | 0.60 | 0.64 | 0.70 |
| | d (mm) | | | | | | | | |
| | shortest distance | 0.75 | 0.75 | 0.75 | 0.70 | 0.70 | 0.60 | 0.75 | 0.75 |
| | da (mm) | | | | | | | | |
| | shortest distance | 0.75 | 0.75 | 0.70 | 0.75 | 0.70 | 0.60 | 0.75 | 0.75 |
| | db (mm) | | | | | | | | |
| | distance | 2.6 | 2.6 | 2.6 | 2.6 | 2.6 | 2.6 | 2.7 | 2.6 |
| | d + r1 + r2 (mm) | | | | | | | | |
| Tread | tread thickness | 30.0 | 30.0 | 29.9 | 29.9 | 29.8 | 30.0 | 30.0 | 30.0 |
| | t (mm) | | | | | | | | |

| | | | | | | | | |
|---|---|---|---|---|---|---|---|---|
| Rolling resistance | 98 | 95 | 95 | 96 | 93 | 92 | 96 | 100 |
| Uneven wear resistance | 100 | 100 | 102 | 103 | 105 | 100 | 104 | 100 |
| Durability of reinforcing | 100 | 100 | 100 | 100 | 100 | 100 | 100 | 100 |
| elements | | | | | | | | |

It is clear from Table 1 that each of the Examples 1 to 7 reduces the rolling resistance as compared to the Comparative Example, while ensuring uneven wear resistance and the durability of the reinforcing elements. It is also clear that Examples 2 to 7 reduce the rolling resistance even more than Example 1.

### REFERENCE SIGNS LIST

1 Heavy-duty pneumatic tire

2 Carcass

2a Carcass body

2b Carcass folded-up portion

2b1 Tire radial outer end

3 Belt

3a Inner belt layer

3b Second belt layer

3c First belt layer

3d Outer belt layer

4 Tread

CL Tire equatorial plane

M Tire maximum width position

1. A heavy-duty pneumatic tire comprising:
a carcass comprising a carcass body extending toroidally between a pair of bead portions and carcass folded-up portions extending from the carcass body and folded up at the bead portions from inside to outside in a tire width direction; and
an inclined belt, further outward in a tire radial direction than a crown portion of the carcass, comprising a first belt layer and a second belt layer further inward in the tire radial direction than the first belt layer, reinforcing elements of the first belt layer and reinforcing elements of the second belt layer extending at an inclination angle of 5° to 30° relative to a tire circumferential direction in such a manner that the reinforcing elements of the first belt layer cross the reinforcing elements of the second belt layer;
wherein an outer edge of the carcass folded-up portions in the tire radial direction is located further inward in the tire radial direction than a tire maximum width position; and
wherein a shortest distance d between the reinforcing elements of the first belt layer and the reinforcing elements of the second belt layer is 0.64 mm or less.

2. The heavy-duty pneumatic tire of claim 1, further comprising:
a tread further outward in the tire radial direction than the inclined belt;
wherein a thickness of the tread is 20 mm to 35 mm.

3. The heavy-duty pneumatic tire of claim 1, further comprising:
a single-layer outer belt layer further outward in the tire radial direction than the inclined belt;
wherein an inclination angle of reinforcing elements of the outer belt layer relative to the tire circumferential direction is greater than the inclination angle of the reinforcing elements of the first belt layer and the reinforcing elements of the second belt layer relative to the tire circumferential direction; and
wherein a shortest distance da between the reinforcing elements of the first belt layer and the reinforcing elements of the outer belt layer is 0.70 mm or less.

4. The heavy-duty pneumatic tire of claim 1, further comprising:
a single-layer inner belt layer further inward in the tire radial direction than the inclined belt;
wherein an inclination angle of reinforcing elements of the inner belt layer relative to the tire circumferential direction is greater than the inclination angle of the reinforcing elements of the first belt layer and the reinforcing elements of the second belt layer relative to the tire circumferential direction; and
wherein a shortest distance db between the reinforcing elements of the second belt layer and the reinforcing elements of the inner belt layer is 0.70 mm or less.

5. The heavy-duty pneumatic tire of claim 1, further comprising:
a single-layer outer belt layer further outward in the tire radial direction than the inclined belt; and
a single-layer inner belt layer further inward in the tire radial direction than the inclined belt;
wherein an inclination angle of reinforcing elements of the outer belt layer and reinforcing elements of the inner belt layer relative to the tire circumferential direction is greater than the inclination angle of the reinforcing elements of the first belt layer and the reinforcing elements of the second belt layer relative to the tire circumferential direction;
wherein a shortest distance da between the reinforcing elements of the first belt layer and the reinforcing elements of the outer belt layer is 0.70 mm or less; and
wherein a shortest distance db between the reinforcing elements of the second belt layer and the reinforcing elements of the inner belt layer is 0.70 mm or less.

6. The heavy-duty pneumatic tire of claim 3, wherein the reinforcing elements of the outer belt layer extend at an inclination angle of 30° to 90° relative to the tire circumferential direction.

7. The heavy-duty pneumatic tire of claim 4, wherein the reinforcing elements of the inner belt layer extend at an inclination angle of 30° to 90° relative to the tire circumferential direction.

8. The heavy-duty pneumatic tire of claim 1, wherein d+r1+r2 is 2.7 mm or more, where r1 is a diameter of the reinforcing elements of the first belt layer and r2 is a diameter of the reinforcing elements of the second belt layer.

9. The heavy-duty pneumatic tire of claim 1, wherein the inclination angle of the reinforcing elements of the second belt layer relative to the tire circumferential direction is smaller than the inclination angle of the reinforcing elements of the first belt layer relative to the tire circumferential direction.

10. The heavy-duty pneumatic tire of claim 2, further comprising:
a single-layer outer belt layer further outward in the tire radial direction than the inclined belt;
wherein an inclination angle of reinforcing elements of the outer belt layer relative to the tire circumferential direction is greater than the inclination angle of the reinforcing elements of the first belt layer and the reinforcing elements of the second belt layer relative to the tire circumferential direction; and
wherein a shortest distance da between the reinforcing elements of the first belt layer and the reinforcing elements of the outer belt layer is 0.70 mm or less.

11. The heavy-duty pneumatic tire of claim 2, further comprising:
a single-layer inner belt layer further inward in the tire radial direction than the inclined belt;
wherein an inclination angle of reinforcing elements of the inner belt layer relative to the tire circumferential direction is greater than the inclination angle of the reinforcing elements of the first belt layer and the reinforcing elements of the second belt layer relative to the tire circumferential direction; and
wherein a shortest distance db between the reinforcing elements of the second belt layer and the reinforcing elements of the inner belt layer is 0.70 mm or less.

12. The heavy-duty pneumatic tire of claim 3, further comprising:
a single-layer inner belt layer further inward in the tire radial direction than the inclined belt;
wherein an inclination angle of reinforcing elements of the inner belt layer relative to the tire circumferential direction is greater than the inclination angle of the reinforcing elements of the first belt layer and the reinforcing elements of the second belt layer relative to the tire circumferential direction; and
wherein a shortest distance db between the reinforcing elements of the second belt layer and the reinforcing elements of the inner belt layer is 0.70 mm or less.

13. The heavy-duty pneumatic tire of claim 2, further comprising:
a single-layer outer belt layer further outward in the tire radial direction than the inclined belt; and
a single-layer inner belt layer further inward in the tire radial direction than the inclined belt;
wherein an inclination angle of reinforcing elements of the outer belt layer and reinforcing elements of the inner belt layer relative to the tire circumferential direction is greater than the inclination angle of the reinforcing elements of the first belt layer and the reinforcing elements of the second belt layer relative to the tire circumferential direction;
wherein a shortest distance da between the reinforcing elements of the first belt layer and the reinforcing elements of the outer belt layer is 0.70 mm or less; and
wherein a shortest distance db between the reinforcing elements of the second belt layer and the reinforcing elements of the inner belt layer is 0.70 mm or less.

14. The heavy-duty pneumatic tire of claim 3, further comprising:
a single-layer outer belt layer further outward in the tire radial direction than the inclined belt; and
a single-layer inner belt layer further inward in the tire radial direction than the inclined belt;
wherein an inclination angle of reinforcing elements of the outer belt layer and reinforcing elements of the inner belt layer relative to the tire circumferential direction is greater than the inclination angle of the reinforcing elements of the first belt layer and the reinforcing elements of the second belt layer relative to the tire circumferential direction;
wherein a shortest distance da between the reinforcing elements of the first belt layer and the reinforcing elements of the outer belt layer is 0.70 mm or less; and
wherein a shortest distance db between the reinforcing elements of the second belt layer and the reinforcing elements of the inner belt layer is 0.70 mm or less.

15. The heavy-duty pneumatic tire of claim 4, further comprising:
a single-layer outer belt layer further outward in the tire radial direction than the inclined belt; and
a single-layer inner belt layer further inward in the tire radial direction than the inclined belt;
wherein an inclination angle of reinforcing elements of the outer belt layer and reinforcing elements of the inner belt layer relative to the tire circumferential direction is greater than the inclination angle of the reinforcing elements of the first belt layer and the reinforcing elements of the second belt layer relative to the tire circumferential direction;
wherein a shortest distance da between the reinforcing elements of the first belt layer and the reinforcing elements of the outer belt layer is 0.70 mm or less; and
wherein a shortest distance db between the reinforcing elements of the second belt layer and the reinforcing elements of the inner belt layer is 0.70 mm or less.

16. The heavy-duty pneumatic tire of claim 5, wherein the reinforcing elements of the outer belt layer extend at an inclination angle of 30° to 90° relative to the tire circumferential direction.

17. The heavy-duty pneumatic tire of claim 5, wherein the reinforcing elements of the inner belt layer extend at an inclination angle of 30° to 90° relative to the tire circumferential direction.

18. The heavy-duty pneumatic tire of claim 2, wherein d+r1+r2 is 2.7 mm or more, where r1 is a diameter of the reinforcing elements of the first belt layer and r2 is a diameter of the reinforcing elements of the second belt layer.

19. The heavy-duty pneumatic tire of claim 3, wherein d+r1+r2 is 2.7 mm or more, where r1 is a diameter of the reinforcing elements of the first belt layer and r2 is a diameter of the reinforcing elements of the second belt layer.

20. The heavy-duty pneumatic tire of claim 4, wherein d+r1+r2 is 2.7 mm or more, where r1 is a diameter of the reinforcing elements of the first belt layer and r2 is a diameter of the reinforcing elements of the second belt layer.
